(19) United States
(12) Patent Application Publication
(10) Pub. No.: US 2026/0135136 A1
(43) Pub. Date: May 14, 2026

(54) PRESSING DEVICE AND CHARGING/DISCHARGING DEVICE

(71) Applicant: SAMSUNG SDI CO., LTD., Yongin-si (KR)

(72) Inventor: Kyung Geun KIM, Suwon-si (KR)

(21) Appl. No.: 19/301,007

(22) Filed: Aug. 15, 2025

(30) Foreign Application Priority Data
Nov. 12, 2024 (KR) 10-2024-0159942

(51) Int. Cl. H01M 10/04; H01M 10/46

(52) U.S. Cl. CPC H01M 10/0481; H01M 10/46

(57) ABSTRACT

A pressing device includes a support plate including a first support plate and a second support plate positioned on both sides of a secondary battery, and a fluid accommodation unit between the secondary battery and the support plate and accommodating a fluid, the fluid accommodation unit being configured to press the secondary battery.

### CROSS-REFERENCE TO RELATED APPLICATION

The present application claims priority to and the benefit of Korean Patent Application No. 10-2024-0159942, filed on Nov. 12, 2024, in the Korean Intellectual Property Office, the entire disclosure of which is incorporated herein by reference.

### BACKGROUND

### 1. Field

Aspects of the present disclosure relate to a pressing device and a charging/discharging device including the pressing device.

### 2. Description of the Related Art

Secondary batteries are batteries that can be charged and discharged, unlike primary batteries that cannot be recharged. Low-capacity secondary batteries are used in small portable electronic devices such as smartphones, feature phones, laptop computers, digital cameras, and camcorders, and high-capacity secondary batteries are widely used as motor driving power sources, power storage batteries, and the like in hybrid vehicles, electric vehicles, and the like. These secondary batteries include an electrode including a positive electrode and/or a negative electrode, an electrode assembly including the electrode, a case that accommodates the electrode assembly, and an electrode terminal connected to the electrode assembly.

As technology advances, high-capacity secondary batteries are desired. Accordingly, to increase battery capacity, a plurality of secondary batteries can be used that are electrically connected to one another. For example, the secondary batteries can be applied to electronic devices in the form of a secondary battery module including a plurality of secondary batteries and/or a secondary battery pack including a plurality of secondary battery modules. In such examples, the electronic devices are electronic devices with high output and/or high capacity and include, for example, electric vehicles and the like.

The above-described information disclosed in the background technology of the present disclosure is only for improving understanding of the background of the present disclosure, and accordingly, may include information that does not constitute the related art.

### SUMMARY

Aspects of embodiments of the present disclosure are directed to a pressing device using a fluid and/or a charging/discharging device including the pressing device.

Aspects of embodiments of the present disclosure are directed to a pressing device that presses and/or heats a secondary battery, and/or a charging/discharging device including the pressing device.

However, technical problems to be solved by the present disclosure are not limited to the above-described problems, and other problems which are not mentioned, will be clearly understood by those skilled in the art from the description of the invention disclosed below.

According to some embodiments of the present disclosure, there is provided a pressing device including: a support plate including a first support plate and a second support plate positioned on both sides of a secondary battery; and a fluid accommodation unit between the secondary battery and the support plate and accommodating a fluid, the fluid accommodation unit being configured to press the secondary battery.

In some embodiments, the pressing device further includes a supply pump configured to supply a fluid to the fluid accommodation unit, wherein the fluid accommodation unit is configured to expand by the supplied fluid and to press the secondary battery.

In some embodiments, the supply pump is configured to supply pneumatic pressure or hydraulic pressure to the fluid accommodation unit.

In some embodiments, the fluid includes at least one of oil, silicone, gel, powder, gas, or a fluid solid.

In some embodiments, the pressing device further includes a driver configured to drive the support plate, wherein the driver is configured to drive the support plate so that the fluid accommodation unit presses the secondary battery.

In some embodiments, the pressing device further includes a sensor configured to measure a pressing force of the fluid accommodation unit against the secondary battery, wherein the supply pump or the driver is configured to control a supply amount of the fluid or driving of the support plate based on the measured pressing force.

In some embodiments, the pressing device further includes a flow path including an inlet through which the fluid is injected into the fluid accommodation unit and an outlet through which the fluid is discharged from the fluid accommodation unit, wherein the fluid accommodation unit is configured to circulate the fluid through the flow path.

In some embodiments, the pressing device further includes a first heating unit that is connected to the flow path and is configured to heat the fluid flowing along the flow path, wherein the fluid accommodation unit is configured to heat the secondary battery with the heated fluid.

In some embodiments, the fluid accommodation unit forms a sealed pouch shape that seals the fluid.

In some embodiments, the pressing device further includes a second heating unit configured to heat the support plate, wherein the fluid accommodation unit is configured to heat the secondary battery with convection heat transferred from the heated support plate.

In some embodiments, the pressing device further includes a sensor that measures a temperature of the secondary battery, wherein a first heating unit or the second heating unit controls a heating degree based on the measured temperature.

In some embodiments, the fluid accommodation unit includes a material having a melting point of 160° C. or higher.

In some embodiments, the pressing device further includes a guide that surrounds at least a portion of an outer portion of the fluid accommodation unit and guides an outer range of the fluid accommodation unit.

In some embodiments, the secondary battery has a pouch shape.

According to some embodiments of the present disclosure, there is provided a charging-discharging device including: a charging-discharging unit electrically connected to a secondary battery; and a pressing device configured to press a secondary battery, and including: a support plate including a first support plate and a second support plate positioned on both sides of the secondary battery; and a fluid accommodation unit between the secondary battery and the support plate and accommodates a fluid, and configured to press the secondary battery.

In some embodiments, the secondary battery includes a pouch-type case that accommodates an electrode assembly, and a tab electrically connected to the electrode assembly and protruding from the pouch-type case; and the charging-discharging unit includes a connection unit connected to the tab and a power supply unit that is configured to supply power to the connection unit.

In some embodiments, the pressing device further includes a supply pump configured to supply a fluid to the fluid accommodation unit; and the fluid accommodation unit is configured to expand by the supplied fluid and to press the secondary battery.

In some embodiments, the pressing device further includes a driver configured to drive the support plate; and the driver is configured to drive the support plate so that the fluid accommodation unit presses the secondary battery.

In some embodiments, the pressing device includes a flow path including an inlet through which the fluid is injected into the fluid accommodation unit and an outlet through which the fluid is discharged from the fluid accommodation unit, and a first heating unit that is connected to the flow path and is configured to heat the fluid flowing along the flow path; and the fluid accommodation unit is configured to heat the secondary battery with the heated fluid.

In some embodiments, the pressing device further includes a second heating unit configured to heat the support plate; and the fluid accommodation unit is configured to heat the secondary battery with convection heat transferred from the heated support plate.

### BRIEF DESCRIPTION OF THE DRAWINGS

The following drawings attached to this specification illustrate preferred embodiments of the present invention and, together with the detailed description of the invention to be described below, serve to further understand the technical idea of the present invention, and therefore the present invention should not be construed as being limited to matters described in such drawings, in which:

FIGS. 1 and 2 are perspective views schematically showing a secondary battery according to some embodiments of the present disclosure;

FIG. 3 is a view schematically showing a pressing device according to some embodiments of the present disclosure;

FIG. 4 is a view schematically showing a secondary battery pressed by the pressing device according to some embodiments of the present disclosure;

FIG. 5 is a view schematically showing a pressing device according to some embodiments of the present disclosure;

FIGS. 6A-6B are side views schematically showing a pressing device according to some embodiments of the present disclosure;

FIG. 7 is a perspective view schematically showing a pressing device according to some embodiments of the present disclosure;

FIG. 8 is a side view schematically showing a fluid accommodation unit according to some embodiments of the present disclosure;

FIG. 9 is a side view schematically showing a portion of a pressing device according to some embodiments of the present disclosure;

FIG. 10 is a view schematically showing a pressing device according to some embodiments of the present disclosure; and

FIG. 11 is a view schematically showing a charging/discharging device according to some embodiments of the present disclosure.

### DETAILED DESCRIPTION

Hereinafter, preferable embodiments of the present disclosure will be described in detail with reference to the accompanying drawings. The terms or words used in the present specification and claims are not to be narrowly interpreted as general or dictionary meanings and should be interpreted to include meanings and concepts that are consistent with the technical idea of the present disclosure on the basis of the principle that an inventor can be his/her own lexicographer to appropriately define concepts of terms to describe his/her invention in the best way. Accordingly, since the embodiments disclosed in the present specification and configurations shown in the drawings are only some of the most preferable embodiments of the present disclosure and do not represent the entire technical spirit of the present disclosure, it should be understood that there are various equivalents and modifications which may replace them at the time of filing the present application.

Further, when used in the present specification, “comprise or include” and/or “comprising or including” specify the presence of mentioned shapes, numbers, steps, operations, members, elements and/or groups thereof, and do not exclude the presence or addition of one or more other shapes, numbers, steps, operations, members, elements and/or groups thereof.

In addition, to aid understanding of the invention, the accompanying drawings may not be shown to scale, and the dimensions of some components may be exaggerated. In addition, the same reference numerals may be given to the same components in different embodiments.

The mention that two objects to be compared are ‘the same’ means that that the two objects are ‘substantially the same.’ Accordingly, ‘substantially the same’ may include a deviation considered as a low level in the art, for example, a deviation within 5%. Further, uniformity of a parameter in a certain region may mean uniformity from an average point of view.

Although first, second, and the like are used to describe various components, it goes without saying that these components are not limited by these terms. These terms are only used to distinguish one component from another component, and unless otherwise stated, it goes without saying that the first component may be the second component.

Throughout the specification, unless otherwise stated, each component may be singular or plural.

The placement of an arbitrary component on the “upper portion (or lower portion)” of a component or “above (or below)” a component may mean not only that the arbitrary component is disposed in contact with an upper surface (or a lower surface) of the component, but also that another component may be interposed between the component and the arbitrary component disposed above (or below) the component.

In addition, when a first component is described as being “connected,” “coupled,” or “joined” to a second component, the components may be directly connected or joined, but it should be understood that a third component may be “interposed” between the components, or the components may be “connected,” “coupled,” or “joined” through the third component. In addition, when a first component is described as being “electrically coupled to” a second component, this includes not only a case in which the first component is “directly coupled” to the second component, but also a case in which the first component is “coupled” to the second component with a third component interposed therebetween.

Throughout the specification, “A and/or B” means to A, B, or A and B unless otherwise stated. That is, “and/or” includes all combinations or any combination of a plurality of listed items. When referring to “C to D,” this means C or more and D or less unless otherwise specified.

The terms used in the present specification is intended to describe the embodiments of the present disclosure, and is not intended to limit the present disclosure.

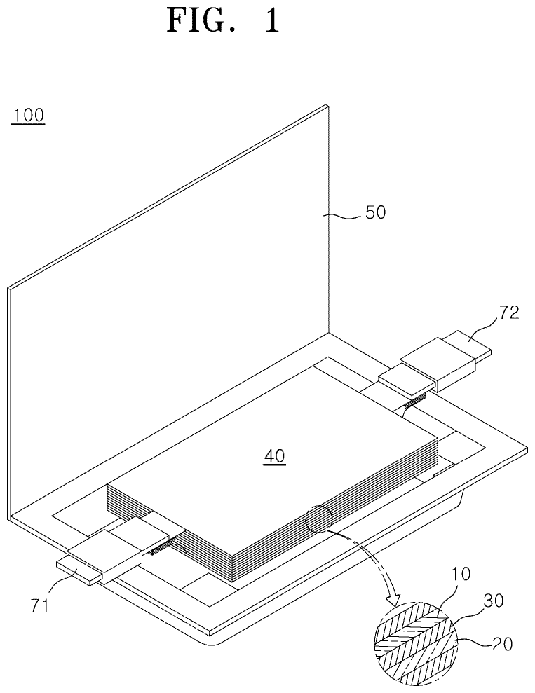

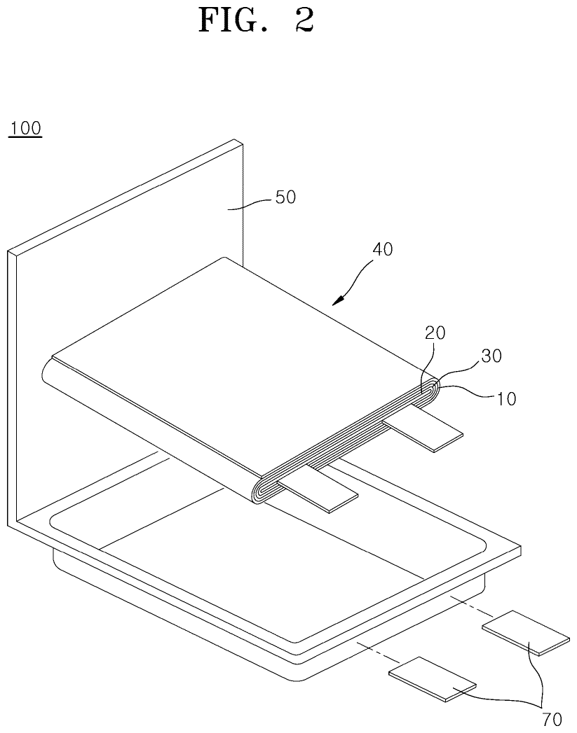

FIGS. 1 and 2 are perspective views schematically showing a secondary battery according to some embodiments of the present disclosure.

The secondary battery 100 may be classified into a cylindrical type, a prismatic type, a pouch type, a coin type, or the like according to its shape. FIGS. 1 and 2 show a pouch-type secondary battery as an example of the secondary battery 100. Referring to FIGS. 1 and 2, the secondary battery 100 may include an electrode assembly 40 in which a separator 30 is interposed between a positive electrode 10 and a negative electrode 20, and a case 50 in which the electrode assembly 40 is built in. The positive electrode 10, the negative electrode 20, and the separator 30 may be impregnated with an electrolyte. For example, the secondary battery 100 may include an electrode tab 70, that is, a positive electrode tab 71 and a negative electrode tab 72, which serve as electrical paths for guiding a current formed in the electrode assembly 40 to the outside.

A compound capable of reversibly intercalating and deintercalating lithium (e.g., a lithiated intercalation compound) may be used as the positive electrode active material. For example, one or more types of a composite oxide of lithium and a metal selected from cobalt, manganese, nickel, and a combination thereof may be used.

The composite oxide may be a lithium transition metal composite oxide, and specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

For example, a compound represented by any one of the chemical formulas below may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high nickel-based positive electrode active material having a nickel content of 80 mol % or more, 85 mol % or more, 90 mol % or more, 91 mol % or more, or 94 mol % or more and 99 mol % or less based on 100 mol % of metals excluding lithium in the lithium transition metal composite oxide. The high nickel-based positive electrode active material may implement high capacity, and thus may be applied to high capacity, high density secondary batteries.

The positive electrode 10 for the secondary battery 100 may include a current collector and a positive electrode active material layer formed on the current collector. The positive electrode active material layer may include a positive electrode active material and further include a binder and/or a conductive material.

For example, the positive electrode may further include an additive capable of serving as a sacrificial positive electrode.

A content of the positive electrode active material may be 90% to 99.5% by weight based on 100% by weight of the positive electrode active material layer and a content of the binder and the conductive material may each be 0.5% to 5% by weight based on 100% by weight of the positive electrode active material layer.

The binder serves to attach particles constituting the positive electrode active material to each other well, and also attach the positive electrode active material to the current collector well. Representative examples of the binder may include polyvinyl alcohol, carboxymethylcellulose, hydroxypropylcellulose, diacetylcellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and the like, but are not limited thereto.

The conductive material is used to impart conductivity to the electrode, and any material which does not cause a chemical change and is electronically conductive may be used. Examples of the conductive material may include a carbon-based material such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer such as a polyphenylene derivative or the like, or a mixture thereof.

Al may be used as the current collector, but the current collector is not limited thereto.

The negative electrode active material includes a material capable of reversibly intercalating and deintercalating lithium ions, lithium metal, an alloy of lithium and a metal, a material capable of doping and dedoping lithium, or a transition metal oxide.

The material capable of reversibly intercalating and deintercalating lithium ions may include a carbon-based negative electrode active material, for example, crystalline carbon, amorphous carbon, or a combination thereof. Examples of the crystalline carbon may include graphite such as amorphous, plate-shaped, flaky, spherical, and/or fibrous natural graphite or artificial graphite, and examples of the amorphous carbon may include soft carbon or hard carbon, mesophase pitch carbide, calcined coke, and/or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the alloy of lithium and a metal.

A Si-based negative electrode active material or Sn-based negative electrode active material may be used as the material capable of doping and dedoping lithium. The Si-based negative electrode active material may include silicon, a silicon-carbon composite, SiOₓ (0<x<2), an Si—Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to some embodiments, the silicon-carbon composite may be in the form of silicon particles whose surfaces are coated with amorphous carbon. For example, the silicon-carbon composite may include a secondary particle (e.g., a core) in which silicon primary particles are assembled, and an amorphous carbon coating layer (e.g., a shell) located on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer located on the surface of the core.

The Si-based negative electrode active material or the Sn-based negative electrode active material may be used in combination with the carbon-based negative electrode active material.

The negative electrode 20 for the secondary battery 100 may include a current collector and a negative electrode active material layer located on the current collector. The negative electrode active material layer may include a negative electrode active material and further include a binder and/or a conductive material.

For example, the negative electrode active material layer may include the negative electrode active material in an amount of 90% to 99.5% by weight, the binder in an amount of 0.5% to 5% by weight, and the conductive material in an amount of 0% to 5% by weight

The binder serves to attach particles constituting the negative electrode active material to each other well, and also attach the negative electrode active material to the current collector well. The binder may be a non-aqueous binder, an aqueous binder, a dry binder, or a combination thereof

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, a cellulose-based compound capable of imparting viscosity may be further included. As the cellulose-based compound, one or more types of carboxymethyl cellulose, hydroxypropylmethyl cellulose, methyl cellulose, and alkali metal salts thereof may be used in combination. Na, K, or Li may be used as the alkali metal.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The conductive material is used to impart conductivity to the electrode, and any material which does not cause a chemical change and is electronically conductive may be used. Specific examples of the conductive material may include a carbon-based material such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer such as a polyphenylene derivative or the like, or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

The electrolyte for the secondary battery 100 includes a non-aqueous organic solvent and a lithium salt.

The non-aqueous organic solvent serves as a medium through which ions involved in an electrochemical reaction of the battery may move.

The non-aqueous organic solvent may be a carbonate-based solvent, an ester-based solvent, an ether-based solvent, a ketone-based solvent, an alcohol-based solvent, an aprotic solvent, or a combination thereof.

As the carbonate-based solvent, dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and/or the like may be used.

As the ester-based solvent, methyl acetate, ethyl acetate, n-propyl acetate, dimethyl acetate, methyl propionate, ethyl propionate, decanolide, mevalonolactone, valerolactone, caprolactone, and/or the like may be used.

As the ether-based solvent, dibutyl ether, tetraglyme, diglyme, dimethoxyethane, 2-methyltetrahydrofuran, 2,5-dimethyltetrahydrofuran, tetrahydrofuran, tetrahydrofuran, and/or the like may be used. Further, as the ketone-based solvent, cyclohexanone may be used. As the alcohol-based solvent, ethyl alcohol, isopropyl alcohol, and/or the like may be used, and as the aprotic solvent, nitriles such as R—CN (R is a linear, branched, or cyclic hydrocarbon group having 2 to 20 carbon atoms and may include double bonds, an aromatic ring, or an ether group) and/or the like, amides such as dimethylformamide and/or the like, dioxolanes such as 1,3-dioxolane, 1,4-dioxolane, and/or the like, sulfolanes, and/or the like may be used.

The non-aqueous organic solvent may be used alone or in a mixture of two or more.

Further, when the carbonate-based solvent is used, a mixture of a cyclic carbonate and a chain carbonate may be used, and the cyclic carbonate and the chain carbonate may be mixed in a volume ratio of 1:1 to 1:9.

The lithium salt is a material that dissolves in an organic solvent and serves as a source of lithium ions in the battery to enable the basic operation of a secondary battery and promote the movement of lithium ions between the positive electrode and the negative electrode. Representative examples of the lithium salts may include one or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate (LiDFOB), and lithium bis(oxalato)borate (LiBOB).

The separator 30 may be present between the positive electrode 10 and the negative electrode 20 depending on the type of secondary battery 100. As the separator 30, polyethylene, polypropylene, polyvinylidene fluoride, or a multilayer film of two or more layers thereof may be used, and a mixed multilayer film such as a polyethylene/polypropylene two-layer separator, a polyethylene/polypropylene/polyethylene three-layer separator, a polypropylene/polyethylene/polypropylene three-layer separator, or the like may be used.

The separator 30 may include a porous substrate and a coating layer containing an organic material, an inorganic material, or a combination thereof located on one surface or both surfaces of the porous substrate.

The porous substrate may be a polymer film formed of one polymer selected from polyolefins such as polyethylene and polypropylene, polyesters such as polyethylene terephthalate and polybutylene terephthalate, polyacetal, polyamide, polyimide, polycarbonate, polyether ketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fibers, Teflon, and polytetrafluoroethylene or a copolymer or mixture of two or more thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present as a mixture in one coating layer, or present in a form in which a coating layer containing an organic material and a coating layer containing an inorganic material are stacked.

The secondary battery 100 may be manufactured through an electrode plate process, an assembly process, and/or a formation process.

The formation process includes a process of activating the assembled secondary battery 100 through pressing and/or heating the secondary battery 100. In such examples, when the pressing and/or heating of the secondary battery 100 is not uniform, the performance of the secondary battery 100 may deteriorate. The performance of the secondary battery 100 includes uniformity, bonding strength between materials, the presence or absence of side reactions, and the like.

Accordingly, a method of uniformly pressing and/or heating the secondary battery 100 will be described below in detail.

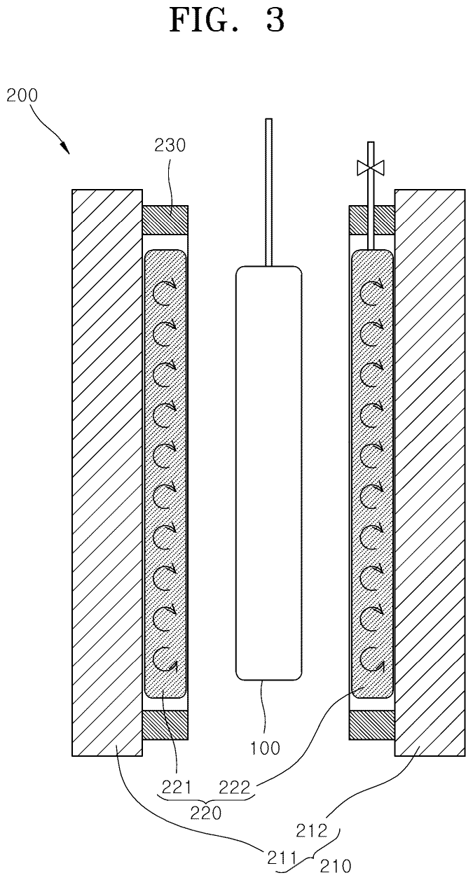

FIG. 3 is a view schematically showing a pressing device according to some embodiments of the present disclosure.

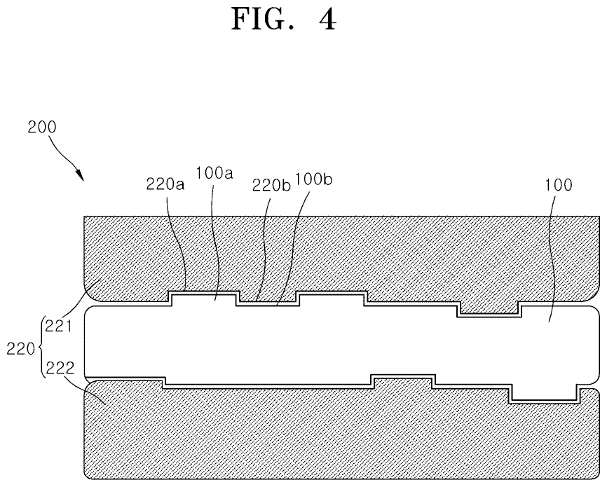

FIG. 4 is a view schematically showing a secondary battery pressed by the pressing device according to some embodiments of the present disclosure.

A pressing device 200 according to some embodiments of the present disclosure includes a support plate 210 including a first support plate 211 and a second support plate 212 disposed on both sides (e.g., opposite sides) of the secondary battery 100 and a fluid accommodation unit 220 that is provided between the secondary battery 100 and the support plate 210 and accommodates a fluid, and the fluid accommodation unit 220 presses the secondary battery 100.

The pressing device 200 presses the secondary battery 100. In such examples, the secondary battery 100 includes, for example, a pouch-type secondary battery 100 described with respect to FIGS. 1 and 2.

The pressing device 200 uniformly presses the secondary battery 100. For example, the pressing device 200 applies a uniform force to the secondary battery 100 on each of one surface and the other surface of the secondary battery 100. In such examples, the forces on one surface and the other surface may be the same or substantially the same.

To this end, as shown in FIG. 3, the pressing device 200 includes the support plate 210 and the fluid accommodation unit 220.

The support plate 210 is disposed to be spaced apart (e.g., offset from) from both surfaces of the secondary battery 100 with the secondary battery 100 interposed therebetween. For example, the support plate 210 includes the first support plate 211 disposed to face one surface of the secondary battery 100 and the second support plate 212 disposed to face the other surface of the secondary battery 100.

The support plate 210 may form or support part or all of the exterior of the pressing device 200. For example, the support plate 210 supports the fluid accommodation unit 220 on at least one surface.

The support plate 210 is formed in a fixed shape. For example, the support plate 210 is formed in a plate shape.

For example, the support plate 210 may be formed to correspond to a shape of one surface of the secondary battery 100. For example, the support plate 210 may be formed in a rectangular plate shape. However, the shape of the support plate 210 is not limited thereto, and the support plate 210 may be formed in any shape, which is suitable for supporting the fluid accommodation unit 220 and/or pressing the fluid accommodation unit 220.

The fluid accommodation unit 220 is located between the support plate 210 and the secondary battery 100. The fluid accommodation unit 220 is located on at least one of both surfaces of the secondary battery 100.

For example, the fluid accommodation unit 220 includes a first fluid accommodation unit 221 located between the first support plate 211 and one surface of the secondary battery 100 and/or a second fluid accommodation unit 222 located between the second support plate 212 and the other surface of the secondary battery 100.

One side of the first fluid accommodation unit 221 faces at least a portion of one surface of the secondary battery 100. For example, one side of the first fluid accommodation unit 221 is in contact with at least a portion of one surface of the secondary battery 100. The other side of the first fluid accommodation unit 221 faces the first support plate 211.

In such examples, the first fluid accommodation unit 221 and the first support plate 211 may be in contact with each other. In some examples, unlike what is shown in FIG. 3, the first fluid accommodation unit 221 and the first support plate 211 may be disposed to face each other but spaced apart from each other. In some examples, unlike what is shown in FIG. 3, additional components may be further disposed between the first fluid accommodation unit 221 and the first support plate 211.

One side of the second fluid accommodation unit 222 faces at least a portion of the other surface of the secondary battery 100. For example, one side of the second fluid accommodation unit 222 is in contact with at least a portion of the other surface of the secondary battery 100. The other side of the second fluid accommodation unit 222 faces the second support plate 212. In such examples, the second fluid accommodation unit 222 and the second support plate 212 may be in contact with each other. In some examples, unlike what is shown in FIG. 3, the second fluid accommodation unit 222 and the second support plate 212 may be disposed to face each other but spaced apart from each other. In some examples, unlike what is shown in FIG. 3, additional components may be further disposed between the second fluid accommodation unit 222 and the second support plate 212.

The fluid accommodation unit 220 accommodates a fluid. For example, the fluid accommodation unit 220 includes a fluid pouch and a fluid accommodated in the fluid pouch.

The fluid pouch includes a material capable of withstanding a force applied to the secondary battery 100. For example, the fluid pouch may include a material with excellent mechanical strength, heat resistance, abrasion resistance, and the like. For example, the fluid pouch may include a rubber-based material, a silicon-based material, or the like.

The fluid is accommodated in the fluid pouch. In some examples, the fluid may have viscosity and/or an insulating property. For example, the fluid may include oil, silicone, gel, powder, or the like. In such examples, the powder represents a particulate solid. For example, the powder may include metal powder, ceramic powder, and/or the like. When the fluid includes powder, the fluid accommodation unit 220 may have high stability. Further, when the fluid includes powder, the fluid accommodation unit 220 may reduce or minimize a volume change. In some examples, the fluid may include gas, a fluid solid, or the like.

The fluid accommodation unit 220 presses the secondary battery 100. For example, the fluid accommodation unit 220 presses the secondary battery 100 by itself. In some examples, the fluid accommodation unit 220 presses the secondary battery 100 while receiving a force from the support plate 210.

The fluid accommodation unit 220 directly presses the secondary battery 100 while being in contact with the secondary battery 100. In such examples, as described above, the fluid accommodation unit 220 includes a fluid. Accordingly, the fluid accommodation unit 220 may be in close contact with the secondary battery 100 along the surface of the secondary battery 100 by a fluid in a non-fixed shape while being in contact with the secondary battery 100.

For example, as shown in FIG. 4, the secondary battery 100 may include a protrusion 100a having a relatively protruding surface and a concave portion 100b having a relatively concave surface. In this way, the secondary battery 100 may have a surface which is not flat and may be uneven.

In such examples, as shown in FIG. 4, the fluid accommodation unit 220 may be in close contact with the protrusion 100a by forming a concave portion 220a corresponding to the protrusion 100a. Further, for example, the fluid accommodation unit 220 may be in close contact with the concave portion 100b by forming a protrusion 220b corresponding to the concave portion 100b. Thus, facing sides of the secondary battery 100 and fluid accommodation unit 220 may have matching surface features.

In this way, the pressing device 200 may uniformly press all areas in contact with the secondary battery 100 regardless of the surface flatness of the secondary battery 100 through the fluidity of the fluid accommodation unit 220. Further, the pressing device 200 may uniformly press the secondary battery 100 regardless of the flatness or pressing position of the equipment.

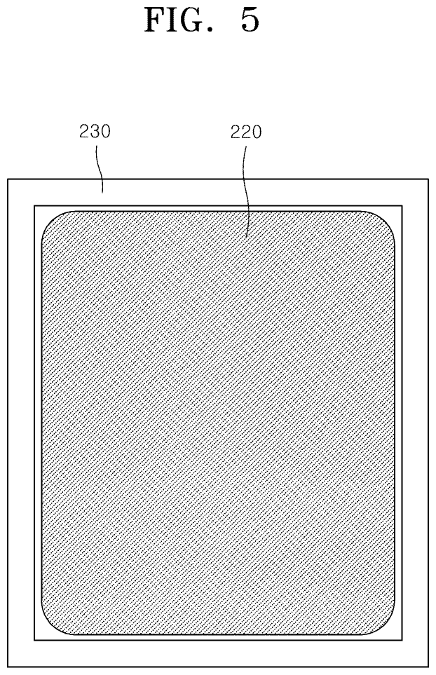

FIG. 5 is a view schematically showing a pressing device according to some embodiments of the present disclosure.

The pressing device 200 may further include a guide 230 to help the fluid accommodation unit 220 to press the secondary battery 100.

The guide 230 is disposed to surround at least a portion of an outer portion of the fluid accommodation unit 220. For example, the guide 230 is located on the support plate 210. The guide 230 is located between the secondary battery 100 and the support plate 210. In some examples, the guide 230 is located to surround all or part of the outer portion of the fluid accommodation unit 220.

The guide 230 guides an outer range of the fluid accommodation unit 220. As described above, the fluid accommodation unit 220 may be formed in a fluid form. In such examples, one surface of the fluid accommodation unit 220 is supported by the support plate 210. The guide 230 supports the outer portion of the fluid accommodation unit 220 which is not supported by the support plate 210.

The guide 230 prevents a shape of the fluid accommodation unit 220 from excessively spreading out by receiving a force from the support plate 210 or the secondary battery 100. The guide 230 may set or guide the maximum outer range of the fluid accommodation unit 220 while being located along the outer portion of the fluid accommodation unit 220. Accordingly, the guide 230 allows the fluid accommodation unit 220 to press the secondary battery 100 more efficiently.

Hereinafter, various ways by which the pressing device 200 presses the secondary battery 100 will be described.

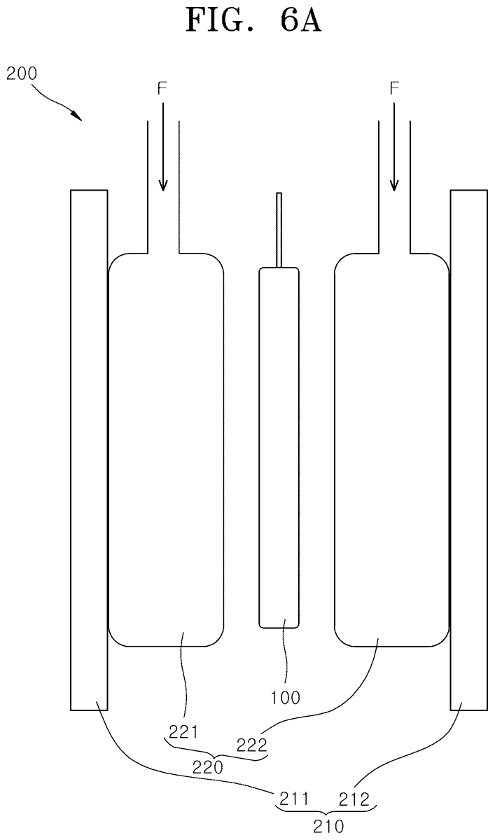

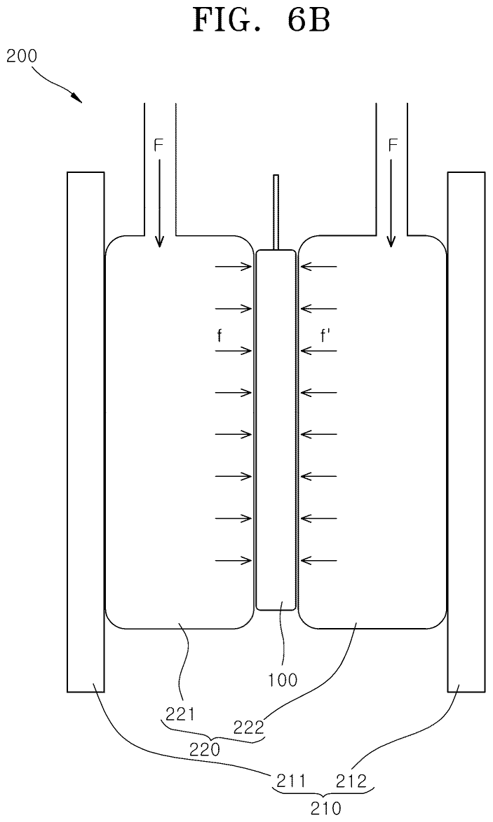

FIGS. 6A-6B are side views schematically showing a pressing device according to some embodiments of the present disclosure.

A pressing device 200 according to some embodiments of the present disclosure includes a support plate 210 including a first support plate 211 and a second support plate 212 disposed on both sides of the secondary battery 100 and a fluid accommodation unit 220, which is provided between the secondary battery 100 and the support plate 210 and accommodates a fluid, and the fluid accommodation unit 220 presses the secondary battery 100.

The pressing device 200 may press the secondary battery 100 through expansion of the fluid accommodation unit 220.

To this end, for example, the pressing device 200 further includes a supply pump which supplies a fluid F to the fluid accommodation unit 220, and the fluid accommodation unit 220 expands by the supplied fluid F and presses the secondary battery 100.

The fluid accommodation unit 220 receives the fluid F from the supply pump.

The supply pump is connected to the fluid accommodation unit 220. For example, the supply pump is connected to a first fluid accommodation unit 221 and/or a second fluid accommodation unit 222. In some examples, the supply pump may be connected to the fluid accommodation unit through a nozzle or pipe through which the fluid F may move.

The supply pump supplies the fluid F to the fluid accommodation unit 220. The fluid F may be the same or substantially the same as a fluid previously accommodated in the fluid accommodation unit 220. In some examples, the fluid F may be different from the fluid previously accommodated in the fluid accommodation unit 220, and may be a fluid F that does not react with the previously accommodated fluid. The supply pump may discharge the fluid F from the fluid accommodation unit 220.

As shown in FIGS. 6A-6B, the fluid accommodation unit 220 expands by the supplied fluid F. The fluid accommodation unit 220 expands toward the secondary battery 100.

For example, the first fluid accommodation unit 221 expands when receiving the fluid F. In such examples, the first fluid accommodation unit 221 may expand relatively more in a direction t toward the secondary battery 100 than in a direction toward the first support plate 211 by the first support plate 211. Accordingly, the first fluid accommodation unit 221 may press one surface of the secondary battery 100.

Further, for example, the second fluid accommodation unit 222 expands when receiving the fluid F. In such examples, the second fluid accommodation unit 222 may expand relatively more in a direction f′ toward the secondary battery 100 than in a direction toward the second support plate 212 by the second support plate 212. Accordingly, the second fluid accommodation unit 222 may press the other surface of the secondary battery 100.

In this way, the fluid accommodation unit 220 may press the secondary battery 100 while being expanded by the fluid F. In such examples, as described with respect to FIGS. 3 and 4, the fluid accommodation unit 220 may uniformly press the secondary battery 100.

The supply pump may further include a valve. The valve may open or close a path which connects the supply pump and the fluid accommodation unit 220. For example, the valve may open or close a nozzle or pipe. When the valve is open, the supply pump may supply the fluid F to the fluid accommodation unit 220 or receive the fluid F from the fluid accommodation unit 220. When the valve is closed, the supply pump may not exchange the fluid F with the fluid accommodation unit 220. The valve may adjust an amount of a fluid flowing along the path through a degree to which the valve is open.

When it is determined that a sufficient amount of fluid has been supplied to the fluid accommodation unit 220, the supply pump may close the valve to block the fluid from being supplied to the fluid accommodation unit 220. In some examples, when it determines that a sufficient amount of fluid has been supplied to the fluid accommodation unit 220, the supply pump may close the valve to prevent the fluid from being discharged from the fluid accommodation unit 220.

For example, the pressing device 200 further includes a sensor that measures a pressing force of the fluid accommodation unit 220 against the secondary battery 100, and the supply pump controls a supply amount of the fluid F based on the measured pressing force.

The sensor measures a pressure applied to the secondary battery 100 from the fluid accommodation unit 220. To this end, for example, the sensor measures a volume of the fluid accommodation unit 220. In some examples, the sensor measures a volume of the secondary battery 100. In some examples, the sensor measures the pressing force of the fluid accommodation unit 220.

For example, the sensor includes a pressure sensor, a volume sensor, a displacement sensor, and the like. In some examples, the sensors may use laser, ultrasonic waves, imaging, light detection and ranging (LIDAR), an electrical signal, pressure, sound, and the like to measure the pressure applied to the secondary battery 100.

For example, the sensor may be mounted on a surface of the fluid accommodation unit 220. In some examples, the sensor may be mounted on a surface of the secondary battery 100. In some examples, the sensor may be located to be spaced apart from the fluid accommodation unit 220 and the secondary battery 100.

The supply pump may control the supply amount of the fluid F based on the pressure measured by the sensor. For example, when the measured pressure is less than a preset pressure range, the supply pump may constantly maintain and/or increase the supply amount of the fluid F. In some examples, the supply pump may supply the fluid F to the fluid accommodation unit 220 by opening the valve or partially opening the valve. For example, when the measured pressure is within the preset pressure range, the supply pump may stop supplying the fluid F. In some examples, the supply pump may close the valve. For example, when the measured pressure exceeds the predetermined pressure range, the supply pump may discharge the fluid F from the fluid accommodation unit 220.

Accordingly, the pressing device 200 may uniformly press the secondary battery 100 with an appropriate force.

In such examples, for example, the supply pump may supply pneumatic pressure or hydraulic pressure to the fluid accommodation unit 220.

For example, the supply pump supplies pneumatic pressure to the fluid accommodation unit 220. The pneumatic pressure represents a case in which air is used as the fluid F to change the pressure. Air is relatively lightweight and operates quickly. Due to the characteristics of air, pneumatic pressure may easily adjust a flow rate or pressure. Accordingly, the supply pump may easily control the pressure, enhance energy efficiency, and/or enhance safety by supplying pneumatic pressure.

In some examples, the supply pump supplies hydraulic pressure to the fluid accommodation unit 220. The hydraulic pressure represents a case in which hydraulic oil is used as the fluid F to change the pressure. Hydraulic oil has a relatively high specific heat and low compressibility. Due to these characteristics of hydraulic oil, hydraulic pressure enables constant and precise pressing. Further, hydraulic pressure is suitable for high pressure. Accordingly, the supply pump may precisely control the pressure and/or provide high pressure by supplying hydraulic pressure.

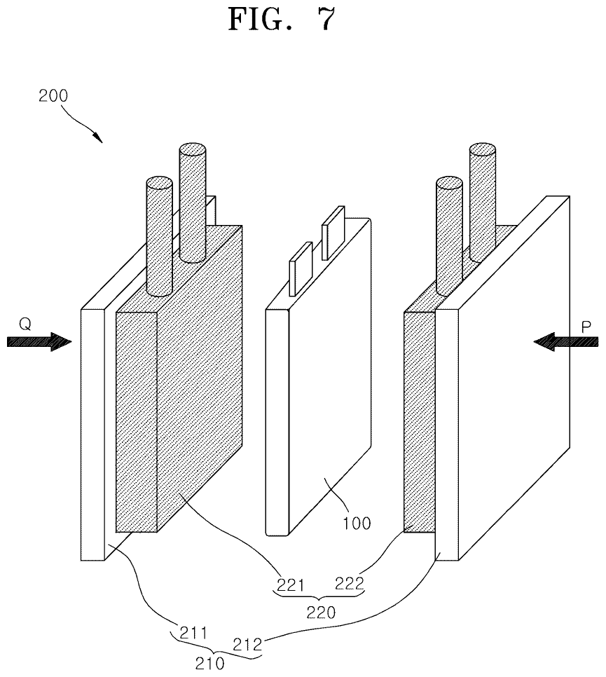

FIG. 7 is a perspective view schematically showing a pressing device according to some embodiments of the present disclosure.

A pressing device 200 according to some embodiments of the present disclosure includes a support plate 210 including a first support plate 211 and a second support plate 212 disposed on both sides of the secondary battery 100 and a fluid accommodation unit 220 which is provided between the secondary battery 100 and the support plate 210 and accommodates a fluid, and the fluid accommodation unit 220 presses the secondary battery 100.

The pressing device 200 may press the secondary battery 100 through a force applied to the fluid accommodation unit 220 by the support plate 210.

To this end, for example, the pressing device 200 further includes a driver driving the support plate 210, and the driver drives the support plate 210 so that the fluid accommodation unit 220 presses the secondary battery 100.

The driver drives the support plate 210. For example, the driver drives the support plate 210 in a width direction of the secondary battery 100. In such examples, the width direction of the secondary battery 100 is parallel to a direction in which the support plate 210 faces the secondary battery 100. The driver may drive the support plate 210 so that the support plate 210 approaches the secondary battery 100. In some examples, the driver may drive the support plate 210 so that the support plate 210 moves away from the secondary battery 100.

For example, the driver may cause the first support plate 211 to move in a direction Q toward the secondary battery 100. The first support plate 211 moves along the Q direction. The first support plate 211 may move the first fluid accommodation unit 221 between the first support plate 211 and the secondary battery 100 while moving along the Q direction. Accordingly, the first fluid accommodation unit 221 may press the secondary battery 100 on one surface.

For example, the driver may cause the second support plate 212 to move in a direction P toward the secondary battery 100. The second support plate 212 moves along the P direction. The second support plate 212 may move the second fluid accommodation unit 222 between the second support plate 212 and the secondary battery 100 while moving along the P direction. Accordingly, the second fluid accommodation unit 222 may press the secondary battery 100 on the other surface.

In this way, the driver may drive the support plate 210 so that the fluid accommodation unit 220 presses the secondary battery 100. In such examples, as described above, the fluid accommodation unit 220 may uniformly press the secondary battery 100.

For example, the pressing device 200 further includes a sensor which measures a pressing force of the fluid accommodation unit 220 against the secondary battery 100, and the driver controls the driving of the support plate 210 based on the measured pressing force.

The sensor measures the pressure applied to the secondary battery 100 from the fluid accommodation unit 220. To this end, for example, the sensor measures a volume of the fluid accommodation unit 220. In some examples, the sensor measures a volume of the secondary battery 100. In some examples, the sensor measures the pressing force of the fluid accommodation unit 220.

For example, the sensor includes a pressure sensor, a volume sensor, a displacement sensor, and the like. For example, the sensors may use laser, ultrasonic waves, imaging, LIDAR, an electrical signal, pressure, sound, and the like to measure the pressure applied to the secondary battery 100.

For example, the sensor may be mounted on a surface of the fluid accommodation unit 220. In some examples, the sensor may be mounted on a surface of the secondary battery 100. In some examples, the sensor may be located to be spaced apart from the fluid accommodation unit 220 and the secondary battery 100.

The driver may control the driving of the support plate 210 based on the pressure measured by the sensor. For example, when the measured pressure is less than a preset pressure range, the driver may cause the support plate 210 to face the secondary battery 100. In some examples, when the measured pressure is within the preset pressure range, the driver may stop the movement of the support plate 210. In some examples, when the measured pressure exceeds the predetermined pressure range, the driver may cause the support plate 210 to move away from the secondary battery 100.

Accordingly, the pressing device 200 may uniformly press the secondary battery 100 with an appropriate force.

The pressing device 200 may include a driver and a supply pump. For example, the pressing device 200 may press the secondary battery 100 simultaneously using a force applied to the fluid accommodation unit 220 by the support plate 210 and a force applied through expansion of the fluid accommodation unit 220.

The pressing device 200 may sequentially or simultaneously heat the secondary battery 100 while pressing the secondary battery 100. Hereinafter, various ways by which the pressing device 200 heats the secondary battery 100 will be described.

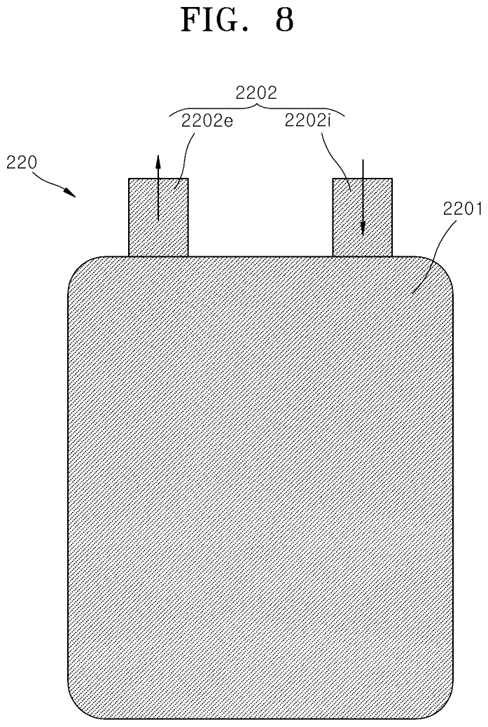

FIG. 8 is a side view schematically showing a fluid accommodation unit according to some embodiments of the present disclosure.

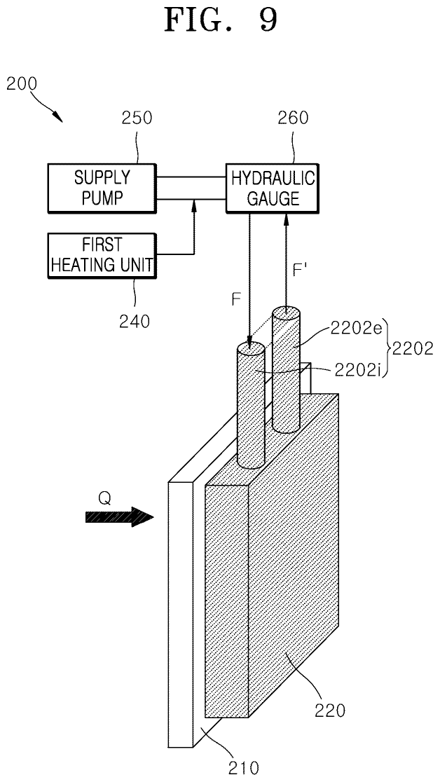

FIG. 9 is a side view schematically showing a portion of a pressing device according to some embodiments of the present disclosure

A pressing device 200 according to some embodiments of the present disclosure includes a support plate 210 including a first support plate 211 and a second support plate 212 disposed on both sides of the secondary battery 100 and a fluid accommodation unit 220 which is provided between the secondary battery 100 and the support plate 210 and accommodates a fluid, and the fluid accommodation unit 220 presses the secondary battery 100.

For example, the fluid accommodation unit 220 includes a flow path 2202 including an inlet 2202i through which the fluid is injected into the fluid accommodation unit 220 and an outlet 2202e through which the fluid is discharged from the fluid accommodation unit 220, and the fluid accommodation unit 220 circulates the fluid through the flow path 2202.

The flow path 2202 is connected to the fluid accommodation unit 220.

For example, the fluid accommodation unit 220 includes a fluid pouch 2201 and a fluid accommodated in the fluid pouch 2201. The flow path 2202 is connected to the fluid pouch 2201. The flow path 2202 provides a path through which the fluid is supplied to the fluid pouch 2201. In some examples, the flow path 2202 provides a path through which the fluid is discharged from the fluid pouch 2201.

The flow path 2202 includes an inlet 2202i providing a path for a fluid F to be injected into the fluid accommodation unit 220 and an outlet 2202e providing a path for a fluid F′ to be discharged from the fluid accommodation unit 220.

The flow path 2202 may be connected to a supply pump 250. In such examples, the supply pump 250 may be the same as or similar to the supply pump described with respect to FIGS. 6A-6B. For example, the flow path 2202 may be connected to the supply pump to inject the fluid into the fluid pouch 2201. In such examples, the flow path 2202 may be used in the same or similar sense as the path described with respect to FIGS. 6A-6B. As shown in FIG. 9, the fluid may be provided from the supply pump 250 to the flow path 2202 through a hydraulic gauge 260.

The fluid may be, for example, the same as or similar to the fluid described with respect to FIGS. 6A-6B. For example, the fluid may include oil, silicone, gel, powder, or the like. In such examples, the powder represents a particulate solid. For example, the powder may include metal powder, ceramic powder, or the like. In some examples, the fluid may include gas, a fluid solid, or the like.

For example, the pressing device 200 includes a first heating unit 240 which is connected to the flow path 2202 and heats the fluid F flowing along the flow path 2202, and the fluid accommodation unit 220 heats the secondary battery 100 through the heated fluid F.

The first heating unit 240 heats the fluid F supplied to the fluid accommodation unit 220. For example, the first heating unit 240 is located at the supply pump 250 and heats the fluid F accommodated in the supply pump 250. In some examples, the first heating unit 240 is located at at least a portion of the flow path 2202 from the supply pump 250 toward the secondary battery 100 and heats the fluid F passing through the flow path 2202. For example, when the fluid F moves from the supply pump 250 toward the secondary battery 100 through the hydraulic gauge 260, the first heating unit 240 may be located between the supply pump 250 and the hydraulic gauge 260.

The first heating unit 240 includes, for example, an electric heater such as a coil heater, a quartz tube heater, a carbon heater, a halogen heater, a positive temperature coefficient (PTC) heater, a near-infrared heater, a far-infrared heater, a ceramic heater, or the like. However, examples of the first heating unit 240 are not limited thereto, and the first heating unit 240 may be formed in any shape capable of applying heat to the fluid F.

As described above, the flow path 2202 transfers the fluid F to the fluid accommodation unit 220. For example, the flow path 2202 transfers the heated fluid F to the fluid accommodation unit 220. In such examples, the fluid F may undergo a phase change while being heated. In some examples, the fluid F may change to a high temperature without a phase change while being heated. In such examples, the fluid F may have a melting point above a temperature to which the first heating unit 240 heats.

For example, the first heating unit 240 may heat the fluid F to 100° C. or higher. In some examples, the first heating unit 240 may heat the fluid F to 110° C. or higher. In some examples, the first heating unit 240 may heat the fluid F to 120° C. or higher. In some examples, the first heating unit 240 may heat the fluid F to 130° C. or higher. In some examples, the first heating unit 240 may heat the fluid F to 140° C. or higher. In some examples, the first heating unit 240 may heat the fluid F to 145° C. or higher. In some examples, the first heating unit 240 may heat the fluid F to 150° C. or higher.

Accordingly, a high-temperature fluid F is supplied into the fluid accommodation unit 220. The fluid accommodation unit 220 may heat the secondary battery 100 which is in contact with the fluid accommodation unit 220 or disposed adjacent to the fluid accommodation unit 220 through the high-temperature fluid F.

For example, the fluid accommodation unit 220 includes a material having a melting point of 160° C. or higher. For example, the fluid pouch 2201 includes a material having a melting point of 160° C. or higher. In some examples, the fluid pouch 2201 may include at least one of polyethylene terephthalate (PET), poly urethane linear, polypropylene (PP), 6, 10 polyamide, 6 polyamide, 6, 6 nylon, polycarbonate (PC), polytetrafluoroethylene (PTFE), polypropylene-homo (PP-homo), a polypropylene-copolymer (a PP-copolymer), polymethyl methacrylate (PMMA), and a combination thereof. Accordingly, the fluid accommodation unit 220 may stably heat the secondary battery 100 while accommodating the high-temperature fluid F.

For example, the pressing device 200 further includes a sensor which measures a temperature of the secondary battery 100, and the first heating unit 240 controls a heating degree based on the measured temperature.

For example, the sensor measures the temperature of the secondary battery 100. To this end, the sensor may be mounted on a surface of the secondary battery 100. In some examples, the sensor measures the temperature of the fluid F injected into the secondary battery 100. To this end, the sensor may be mounted on the surface of the flow path 2202 and/or the fluid pouch 2201. In some examples, the sensor may be spaced apart from the secondary battery 100, the flow path 2202, and/or the fluid pouch 2201 to measure the temperatures of the secondary battery 100, the flow path 2202, and/or the fluid pouch 2201 from a long distance.

For example, the sensor includes a contact temperature sensor or a non-contact temperature sensor. In some examples, the sensor may include a thermocouple, a resistance sensor, a thermistor, or the like.

The first heating unit 240 heats the fluid F when the measured temperature is lower than a preset temperature range. The first heating unit 240 stops heating the fluid F when the measured temperature is within the preset temperature range. The first heating unit 240 may lower the temperature of the fluid F when the measured temperature exceeds the preset temperature range. In some examples, In such examples, the supply pump 250 may additionally supply a fluid F which is not heated by the first heating unit 240 to the fluid accommodation unit 220.

Accordingly, the pressing device 200 may heat the secondary battery 100 within an appropriate temperature range.

The pressing device 200 according to some embodiments of the present disclosure may concurrently (e.g., simultaneously) press and heat the secondary battery 100.

For example, the pressing device 200 may concurrently (e.g., simultaneously) perform the pressing process described with respect to FIGS. 6A-6B and the heating process described with respect to FIGS. 8 and 9. For example, the pressing device 200 may press the secondary battery 100 by causing the fluid accommodation unit 220 to expand by the fluid F supplied from the supply pump 250. Concurrently (e.g., simultaneously), the pressing device 200 may heat the secondary battery 100 by supplying a high-temperature fluid F to the fluid accommodation unit 220.

In some examples, the pressing device 200 may concurrently (e.g., simultaneously) perform the pressing process described with respect to FIG. 7 and the heating process described with respect to FIGS. 8 and 9. For example, the pressing device 200 may cause the fluid accommodation unit 220 to press the secondary battery 100 through the support plate 210. Concurrently (e.g., simultaneously), the pressing device 200 may heat the secondary battery 100 by supplying the high-temperature fluid F to the fluid accommodation unit 220.

In some examples, the pressing device 200 may perform the heating process described with respect to FIGS. 8 and 9 while performing a combination of the pressing process described with respect to FIGS. 6A-6B and the pressing process described with respect to FIG. 7.

Through this method, the pressing device 200 may uniformly press and heat the secondary battery 100.

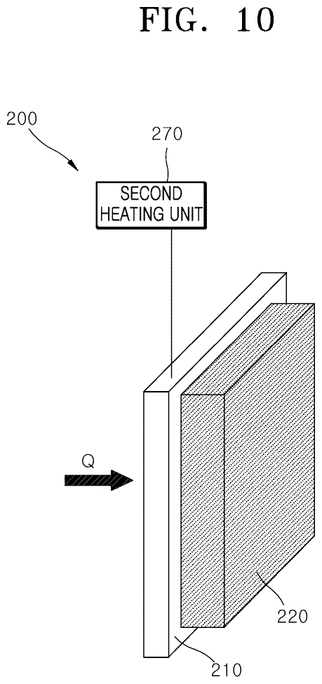

FIG. 10 is a view schematically showing a pressing device according to some embodiments of the present disclosure.

A pressing device 200 according to some embodiments of the present disclosure includes a support plate 210 including a first support plate 211 and a second support plate 212 disposed on both sides of the secondary battery 100 and a fluid accommodation unit 220 which is provided between the secondary battery 100 and the support plate 210 and accommodates a fluid, and the fluid accommodation unit 220 presses the secondary battery 100.

For example, the fluid accommodation unit 220 forms a sealed pouch shape which seals a fluid F.

The fluid accommodation unit 220 may be sealed after accommodating the fluid F. Accordingly, the fluid accommodation unit 220 may not receive the fluid F from the outside. In some examples, the fluid accommodation unit 220 may not exchange the fluid F with the outside.

The pressing device 200 may further include a guide 230. As described with respect to FIGS. 3 and 4, the guide 230 is located to surround at least a portion of an outer portion of the fluid accommodation unit 220. For example, the guide 230 may be located to surround the entire outer portion of the fluid accommodation unit 220.

The guide 230 may prevent at least a portion of the fluid accommodation unit 220 from separating from the secondary battery 100 during a pressing process.

For example, the pressing device 200 further includes a second heating unit 270 which heats the support plate 210, and the fluid accommodation unit 220 heats the secondary battery 100 with convection heat transferred from the heated support plate 210.

The second heating unit 270 heats the support plate 210. For example, the second heating unit 270 may heat the support plate 210 while being in contact with the support plate 210 and/or being located adjacent to the support plate 210.

The second heating unit 270 includes, for example, an electric heater such as a coil heater, a quartz tube heater, a carbon heater, a halogen heater, a PTC heater, a near-infrared heater, a far-infrared heater, a ceramic heater, or the like. However, examples of the second heating unit 270 are not limited thereto, and the second heating unit 270 may be formed in any shape capable of applying heat to the support plate 210. For example, the second heating unit 270 may be formed in the form of a heating wire installed on the support plate 210.

For example, the second heating unit 270 may heat the support plate 210 to 100° C. or higher. In some examples, the second heating unit 270 may heat the support plate 210 to 110° C. or higher. In some examples, the second heating unit 270 may heat the support plate 210 to 120° C. or higher. In some examples, the second heating unit 270 may heat the support plate 210 to 130° C. or higher. In some examples, the second heating unit 270 may heat the support plate 210 to 140° C. or higher. In some examples, the second heating unit 270 may heat the support plate 210 to 145° C. or higher. In some examples, the second heating unit 270 may heat the support plate 210 to 150° C. or higher.

In such examples, the second heating unit 270 may heat both the first support plate 211 and the second support plate 212. In some examples, the second heating unit 270 may heat only one of the first support plate 211 and the second support plate 212.

The heated support plate 210 transfers heat to the secondary battery 100 through the fluid accommodation unit 220. For example, the support plate 210 transfers heat to the secondary battery 100 through heat convection and/or heat conduction. Accordingly, the second heating unit 270 may heat the secondary battery 100.

In such examples, as described with respect to FIGS. 8 and 9, the fluid accommodation unit 220 may include a material having a melting point of 160° C. or higher. For example, the fluid accommodation unit 220 may include at least one of PET, poly urethane linear, PP, 6, 10 polyamide, 6 polyamide, 6, 6 nylon, PC, PTFE, PP-homo, a PP-copolymer, PMMA, and a combination thereof. Accordingly, the fluid accommodation unit 220 may stably maintain its shape while being in contact with a high-temperature support plate 210. Further, the fluid accommodation unit 220 may stably supply heat to the secondary battery 100.

For example, the pressing device 200 further includes a sensor which measures a temperature of the secondary battery 100, and the second heating unit 270 controls a heating degree based on the measured temperature.

For example, the sensor measures the temperature of the secondary battery 100. To this end, the sensor may be mounted on a surface of the secondary battery 100. In some examples, the sensor measures a temperature of the support plate 210. To this end, the sensor may be mounted on a surface of the support plate 210. In some examples, the sensor measures a temperature of the fluid accommodation unit 220. To this end, the sensor may be mounted on a surface of the fluid accommodation unit 220. In some examples, the sensor may be spaced apart from the secondary battery 100, the support plate 210, and/or the fluid accommodation unit 220 to measure the temperatures of the secondary battery 100, the support plate 210, and/or the fluid accommodation unit 220 from a long distance.

For example, the sensor includes a contact temperature sensor or a non-contact temperature sensor. For example, the sensor may include a thermocouple, a resistance sensor, a thermistor, or the like.

The second heating unit 270 heats the support plate 210 when the temperature measured by the sensor is lower than a preset temperature range. The second heating unit 270 stops heating when the temperature measured by the sensor is within the preset temperature range. The second heating unit 270 may lower the temperature of the support plate 210 when the temperature measured by the sensor exceeds the preset temperature range.

Accordingly, the pressing device 200 may heat the secondary battery 100 within an appropriate temperature range.

The pressing device 200 according to some embodiments of the present disclosure may concurrently (e.g., simultaneously) press and heat the secondary battery 100.

In some examples, the pressing device 200 may concurrently (e.g., simultaneously) perform the pressing process described with respect to FIG. 7 and the heating process described with respect to FIGS. 9-10. For example, the pressing device 200 may cause the fluid accommodation unit 220 to press the secondary battery 100 through the support plate 210. Concurrently (e.g., simultaneously), the pressing device 200 may cause the support plate 210 to heat the secondary battery 100 using heat convection and/or heat conduction.

Through this method, the pressing device 200 may uniformly press and heat the secondary battery 100.

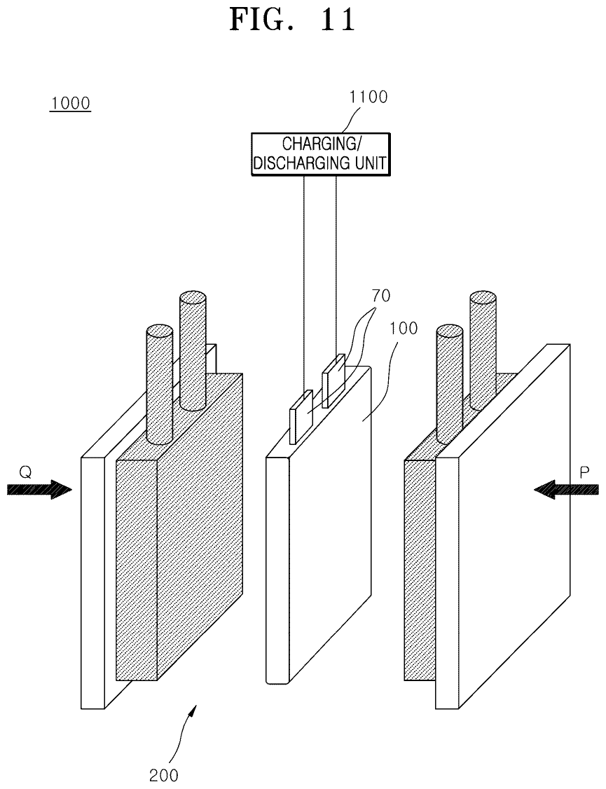

FIG. 11 is a view schematically showing a charging/discharging device according to some embodiments of the present disclosure.

A charging/discharging device (also referred to as charging-discharging device) 1000 according to some embodiments of the present disclosure includes a pressing device 200 which presses a secondary battery 100 and a charging/discharging unit 1100 electrically connected to the secondary battery 100, the pressing device 200 includes a support plate 210 including a first support plate 211 and a second support plate 212 disposed on both surfaces of the secondary battery 100 and a fluid accommodation unit 220, which is disposed between the secondary battery 100 and the support plate 210 and accommodates a fluid, and the fluid accommodation unit 220 presses the secondary battery 100.

The pressing device 200 is a device which presses the secondary battery 100. Further, the pressing device 200 is a device, which presses and/or heats the secondary battery 100. The pressing device 200 may include, for example, at least one of the pressing devices 200 described with respect to FIGS. 3 to 11.

For example, the pressing device 200 further includes a supply pump, which supplies a fluid to the fluid accommodation unit 220, and the fluid accommodation unit 220 expands by the supplied fluid and presses the secondary battery 100.

For example, the pressing device 200 further includes a driver, which drives the support plate 210, and the driver drives the support plate 210 so that the fluid accommodation unit 220 presses the secondary battery 100.

However, a method by which the pressing device 200 according to some embodiments of the present disclosure presses the secondary battery 100 is not limited thereto.

For example, the pressing device 200 includes a flow path 2202 including an inlet 2202i through which the fluid is injected into the fluid accommodation unit 220 and an outlet 2202e through which the fluid is discharged from the fluid accommodation unit 220, and a first heating unit 240 which is connected to the flow path 2202 and heats the fluid flowing along the flow path 2202, and the fluid accommodation unit 220 heats the secondary battery 100 through the heated fluid.

For example, the pressing device 200 further includes a second heating unit 270 which heats the support plate 210, and the fluid accommodation unit 220 heats the secondary battery 100 through convection heat transferred from the heated support plate 210.

However, a method by which the pressing device 200 according to some embodiments of the present disclosure heats the secondary battery 100 is not limited thereto.

The secondary battery 100 includes a pouch-type case 50, which accommodates an electrode assembly 40, and a tab 70 electrically connected to the electrode assembly 40 and protruding from the case 50. The tab 70 includes the positive electrode tab 71 and/or the negative electrode tab 72 described with respect to FIGS. 1 and 2.

The charging/discharging unit 1100 includes a connection unit connected to the tab 70 and a power supply unit, which supplies power to the connection unit. The power supply unit supplies power to the secondary battery 100 through the tab 70.

For example, the charging/discharging unit 1100 charges the secondary battery 100. For example, the charging/discharging unit 1100 may charge the secondary battery 100 to a full charge potential. In some examples, the charging/discharging unit 1100 may charge the secondary battery 100 to a portion of the full charge potential. In such examples, the full charge potential may be the same or substantially the same as the capacity of the secondary battery 100.

In some examples, the charging/discharging unit 1100 discharges the secondary battery 100. For example, the charging/discharging unit 1100 may fully or partially discharge the charged secondary battery 100.

The charging/discharging device 1000, according to some embodiments of the present disclosure may stably charge/discharge the secondary battery 100 by uniformly pressing and/or heating the secondary battery 100. Accordingly, the charging/discharging device 1000 may activate the secondary battery 100 and/or confirm the stability of the secondary battery 100.

According to the present disclosure, a secondary battery can be uniformly pressed.

According to the present disclosure, an electrolyte can be prevented from stagnating in the secondary battery or the possibility thereof can be substantially reduced.

According to the present disclosure, the lifespan of the secondary battery can be improved (e.g., increased).

According to the present disclosure, side reactions of the secondary battery can be improved (e.g., increased).

However, technical effects acquirable through the present disclosure are not limited to the above-described technical effects, and other technical effects which are not mentioned will be clearly understood by those skilled in the art from the description of the invention described below.

Although the present disclosure has been described above by limited embodiments and drawings, the present disclosure is not limited thereto, and various modifications and variations may be made by those skilled in the art within the spirit of the present disclosure and the equivalent the scope of which is defined by the claims to be described below and their equivalents.

What is claimed is:

1. A pressing device comprising:
a support plate comprising a first support plate and a second support plate positioned on both sides of a secondary battery; and
a fluid accommodation unit between the secondary battery and the support plate and accommodating a fluid, the fluid accommodation unit being configured to press the secondary battery.

2. The pressing device of claim 1, further comprising a supply pump configured to supply a fluid to the fluid accommodation unit,
wherein the fluid accommodation unit is configured to expand by the supplied fluid and to press the secondary battery.

3. The pressing device of claim 2, wherein the supply pump is configured to supply pneumatic pressure or hydraulic pressure to the fluid accommodation unit.

4. The pressing device of claim 1, wherein the fluid comprises at least one of oil, silicone, gel, powder, gas, or a fluid solid.

5. The pressing device of claim 2, further comprising a driver configured to drive the support plate,
wherein the driver is configured to drive the support plate so that the fluid accommodation unit presses the secondary battery.

6. The pressing device of claim 5, further comprising a sensor configured to measure a pressing force of the fluid accommodation unit against the secondary battery,
wherein the supply pump or the driver is configured to control a supply amount of the fluid or driving of the support plate based on the measured pressing force.

7. The pressing device of claim 1, further comprising a flow path comprising an inlet through which the fluid is injected into the fluid accommodation unit and an outlet through which the fluid is discharged from the fluid accommodation unit,
wherein the fluid accommodation unit is configured to circulate the fluid through the flow path.

8. The pressing device of claim 7, further comprising a first heating unit that is connected to the flow path and is configured to heat the fluid flowing along the flow path,
wherein the fluid accommodation unit is configured to heat the secondary battery with the heated fluid.

9. The pressing device of claim 1, wherein the fluid accommodation unit forms a sealed pouch shape that seals the fluid.

10. The pressing device of claim 9, further comprising a second heating unit configured to heat the support plate,
wherein the fluid accommodation unit is configured to heat the secondary battery with convection heat transferred from the heated support plate.

11. The pressing device of claim 10, further comprising a sensor that measures a temperature of the secondary battery,
wherein a first heating unit or the second heating unit controls a heating degree based on the measured temperature.

12. The pressing device of claim 1, wherein the fluid accommodation unit comprises a material having a melting point of 160° C. or higher.

13. The pressing device of claim 1, further comprising a guide that surrounds at least a portion of an outer portion of the fluid accommodation unit and guides an outer range of the fluid accommodation unit.

14. The pressing device of claim 1, wherein the secondary battery has a pouch shape.

15. A charging-discharging device comprising:
a charging-discharging unit electrically connected to a secondary battery; and
a pressing device configured to press a secondary battery, and comprising:
a support plate comprising a first support plate and a second support plate positioned on both sides of the secondary battery; and
a fluid accommodation unit between the secondary battery and the support plate and accommodates a fluid, and configured to press the secondary battery.

16. The charging-discharging device of claim 15, wherein:
the secondary battery comprises a pouch-type case that accommodates an electrode assembly, and a tab electrically connected to the electrode assembly and protruding from the pouch-type case; and
the charging-discharging unit comprises a connection unit connected to the tab and a power supply unit that is configured to supply power to the connection unit.

17. The charging-discharging device of claim 15, wherein:
the pressing device further comprises a supply pump configured to supply a fluid to the fluid accommodation unit; and
the fluid accommodation unit is configured to expand by the supplied fluid and to press the secondary battery.

18. The charging-discharging device of claim 15, wherein:
the pressing device further comprises a driver configured to drive the support plate; and
the driver is configured to drive the support plate so that the fluid accommodation unit presses the secondary battery.

19. The charging-discharging device of claim 15, wherein:
the pressing device comprises a flow path comprising an inlet through which the fluid is injected into the fluid accommodation unit and an outlet through which the fluid is discharged from the fluid accommodation unit, and a first heating unit that is connected to the flow path and is configured to heat the fluid flowing along the flow path; and
the fluid accommodation unit is configured to heat the secondary battery with the heated fluid.

20. The charging-discharging device of claim 15, wherein:
the pressing device further comprises a second heating unit configured to heat the support plate; and
the fluid accommodation unit is configured to heat the secondary battery with convection heat transferred from the heated support plate.
